(19) United States
(12) Patent Application Publication
(10) Pub. No.: US 2026/0035188 A1
(43) Pub. Date: Feb. 5, 2026

(54) TRANSPORT APPARATUS FOR CONTAINERS, AND SYSTEM FOR PROCESSING CONTAINERS

(71) Applicant: Bausch + Stroebel SE + Co. KG, Ilshofen (DE)

(72) Inventors: Manuel Wallisch, Ilshofen (DE); Andreas Boehmike, Ilshofen (DE)

(21) Appl. No.: 19/355,037

(22) Filed: Oct. 10, 2025

Related U.S. Application Data
(63) Continuation of application No. PCT/EP2024/059636, filed on Apr. 9, 2024.

(30) Foreign Application Priority Data
Apr. 13, 2023 (DE) 10 2023 109 343.6

(51) Int. Cl. B65G 47/84; B65B 43/60

(52) U.S. Cl. CPC B65G 47/846; B65B 43/60; B65G 2811/0636

(57) ABSTRACT

A container transport apparatus includes a base device and a put-on-device. The base device has a support body and a first coupling element that can be driven in rotation via a drive unit. The support body has a connecting portion facing the put-on-device, on which a receiving chamber is formed in which the first coupling element is arranged. The put-on-device has a transport body with a container receptacle for a container, a second coupling element connected to the transport body in a rotationally fixed manner, and a put-on-body. The coupling elements magnetically couple together to drive the transport body. The put-on-body rests against the connecting portion and is connected to the connecting portion via a force-locking and/or positive-locking connection. The transport body is rotatable relative to the put-on-body, covers the put-on-body, and projects radially beyond the put-on-body. The transport apparatus can be part of a system for processing containers.

### CROSS-REFERENCE TO RELATED APPLICATIONS

This application is a continuation patent application of international application number PCT/EP2024/059636, filed on Apr. 9, 2024, and claims the benefit of German application number 10 2023 109 343.6, filed Apr. 13, 2023, which are incorporated herein by reference in their entirety and for all purposes.

### FIELD

The present disclosure relates to a transport apparatus for containers, in particular pharmaceutical containers, and a system for processing containers, in particular pharmaceutical containers, which comprises at least one transport apparatus.

### BACKGROUND

In such a system, the containers, which are in particular pharmaceutical containers, can, for example, pass through different stations. These include, for example, at least one weighing station, a filling station and a closing station. For feeding or coupling the containers, for removing and uncoupling them and for transporting them from station to station, the system usually provides transport apparatuses, which, for example, comprise transport wheels or can be configured as such, in which a plurality of container receptacles are usually arranged on an outer circumference of a transport body (also referred to as a “transport star”). With regard to any hygiene requirements, it is desirable, for example, to be able to clean the transport apparatus as easily as possible, wherein residues are avoided whenever possible. It may also be desirable to configure the transport apparatus as closed as possible, so that no particles, for example due to abrasion, can escape to the outside and lead to the contamination of the system.

The containers can be configured in various ways. These can be, for example, vials, syringes, cartridges or ampoules.

An object underlying the present disclosure is to provide a transport apparatus for containers and a system for processing containers with a transport apparatus that has improved cleaning properties.

### SUMMARY

In a first aspect of the disclosure, a transport apparatus for containers, in particular pharmaceutical containers, comprising a base device and an put-on-device is provided. The base device comprises a support body for the put-on-device and a first coupling element that can be driven in rotation about a rotational axis via a drive unit. The support body has a connecting portion facing the put-on-device, on which a receiving chamber is formed in which the first coupling element is arranged. The put-on-device comprises a transport body with at least one container receptacle for a container, preferably a plurality of container receptacles, a second coupling element that is connected to the transport body in a rotationally fixed manner and a put-on-body. The coupling elements are mutually spaced and magnetically couple together in order to drive the transport body about the rotational axis. The put-on-body rests against the connecting portion and is connected to the connecting portion in particular via a force-locking and/or positive-locking connection. The transport body is configured to be rotatable relative to the put-on-body, covers the same and projects beyond the put-on-body in the radial direction.

In a second aspect of the disclosure, a system for processing containers, in particular pharmaceutical containers is provided. The system comprises a frame and at least one transport apparatus in accordance with the first aspect.

### BRIEF DESCRIPTION OF THE DRAWINGS

The foregoing summary and the following description may be better understood in conjunction with the drawing figures, of which:

FIG. 1: is a schematic representation of the system in accordance with the disclosure for processing containers, comprising a transport apparatus;

FIG. 2: shows the transport apparatus in accordance with the disclosure in a perspective partial representation;

FIG. 3: is a longitudinal sectional view of the transport apparatus;

FIG. 4 is an enlarged view of detail A in FIG. 3;

FIG. 5: is a perspective partial representation of the transport apparatus in an exploded view; and

FIG. 6: is a partial representation of the transport apparatus in accordance with the disclosure and shows a decoupling mechanism for the transport apparatus in a schematic representation.

### DETAILED DESCRIPTION

Although the disclosure is illustrated and described herein with reference to specific embodiments, the disclosure is not intended to be limited to the details shown. Rather, various modifications may be made in the details within the scope and range of equivalents and without departing from the disclosure.

The present disclosure relates to a transport apparatus for containers, in particular pharmaceutical containers, comprising a base device and an put-on-device. The base device comprises a support body for the put-on-device and a first coupling element that can be driven in rotation about a rotational axis via a drive unit. The support body has a connecting portion facing the put-on-device, on which a receiving chamber is formed in which the first coupling element is arranged. The put-on-device comprises a transport body with at least one container receptacle for a container, preferably a plurality of container receptacles, a second coupling element that is connected to the transport body in a rotationally fixed manner and a put-on-body. The coupling elements are mutually spaced and magnetically couple together in order to drive the transport body about the rotational axis. The put-on-body rests against the connecting portion and is connected to the connecting portion in particular via a force-locking and/or positive-locking connection. The transport body is configured to be rotatable relative to the put-on-body, covers the same and projects beyond the put-on-body in the radial direction.

In the transport apparatus in accordance with the disclosure, the containers can be transported via the at least one and preferably the plurality of container receptacles on the transport body, which is placed via the put-on-body on the base device, in particular its support body. The put-on-body is preferably connected in a positive-locking and/or force-locking manner to the connecting portion, against which the put-on-body rests at least in sections. As a result, the connecting portion can advantageously be at least partially covered by the put-on-body and thus also the receiving chamber arranged on the connecting portion with the first coupling element. As a result, a sealing of the receiving chamber outwards and from the outside can preferably be achieved. The rotational motion is transmitted via the coupling elements, which are mutually spaced and not connected to one another but are coupled by a magnetic force. Here, the second coupling element can be arranged on the put-on-device, for example, between the put-on-body and the transport body. Advantageously, sealing outwards and from the outside is also achieved via the put-on-body and/or the transport body. The transport body covers the put-on-body and projects beyond it in the radial direction. Advantageously, the transport body can “shield” the put-on-body to a certain extent from external influences (for example, from above). As a result, the transport apparatus can also be suitable for on-site cleaning tasks (WIP, washing-in-place) in the system and does not need to be dismantled for these cleaning tasks.

The following statements relate in particular to an embodiment of the disclosure in which the put-on-device is placed on the base device from above in the direction of gravity, in the intended use of the transport apparatus. However, the present disclosure is not limited to this. It is conceivable, for example, that the put-on-device is “placed” on the base device from the side or from below. Typically, however, the transport apparatus in accordance with the disclosure will be used in such an orientation in which the put-on-device is arranged above the base device, wherein “above” refers to the direction of gravity.

In the present case, “axial”, “radial” and “circumferential” refer to the rotational axis. In the present case, “axial” can also be understood as “running parallel to the rotational axis”.

It may be advantageous if the put-on-body at least partially and preferably completely covers the support body at the connecting portion. As a result, the support body can be advantageously sealed to the outside at the connecting portion.

It can be advantageous if the put-on-body comprises or forms a planar contact element for surface-to-surface contact with the connecting portion. As a result, a defined target position of the put-on-body and thus of the put-on-device can be ensured. In particular, the put-on-body can rest against a cover element of the support body covering the receiving chamber, wherein the cover element can close the receiving chamber.

Advantageously, the put-on-body engages over the connecting portion and comprises an edge element that surrounds the connecting portion radially on the outside at least in sections and preferably completely. In this way, for example, the connecting portion can be sealed radially outwards or from the outside. The edge element can preferably rest against the connecting portion at least in sections and in particular completely along an outer circumference.

Preferably, the edge element extends axially over the height of the receiving chamber. Alternatively or additionally, the edge element can, for example, extend over the height of a cover element of the support body covering the receiving chamber.

The put-on-body can, for example, be made of an elastically deformable material. This makes it possible, for example, to ensure a suitable positive-locking fit of the put-on-body on the connecting portion. Preferably, a force-fitting connection or frictional connection is achieved in such a way that separate connecting elements are unnecessary.

For example, the put-on-body is made of polyoxymethylene (POM), polyethylene (PE) or polyetheretherketone (PEEK).

The put-on-body is, for example, snapped onto the connecting portion and can, for this purpose, preferably be made of the elastically deformable material.

Advantageously, the put-on-body is detachably connectable to the connecting portion, wherein in particular the put-on-device is detachably connectable to the base device via the put-on-body. This makes it possible, for example, for a number of different put-on-devices to be selectively connected to the base device. These put-on-devices or their transport bodies can, for example, be container-specific format parts.

The put-on-body can, for example, be configured in one piece.

In an exemplary embodiment of the disclosure, the put-on-body can comprise an edge element pointing away from the support body, which at least partially and preferably completely surrounds a receiving chamber for the second coupling element in a circumferential direction. For example, the edge element protrudes from the above-mentioned planar contact element of the put-on-body. The edge element can enclose the second coupling element and thereby preferably seal it outwards or from the outside.

It may be advantageous if the transport body covers the last-mentioned receiving chamber for the second coupling element and projects radially beyond the receiving chamber. This can ensure better protection of the second coupling element in the receiving chamber.

A particularly central opening can be formed on the second coupling element, into which the transport body can engage with a projection. For example, the second coupling element surrounds the projection in a positive-locking manner. The projection can, for example, rest in the region of the opening on the put-on-body, for example the above-mentioned planar contact element.

It may be advantageous if a sealing element is arranged in the radial direction between an edge element of the put-on-body and an edge element of the transport body for sealing an intermediate space between the put-on-body and the transport body. As a result, the entry of substances, for example in WIP applications, can be avoided. In this way, the release of particles can be avoided.

In practice, it may prove advantageous if the sealing element is a shaft sealing ring or comprises a shaft sealing ring.

The put-on-device advantageously comprises a bearing element via which the transport body can be rotated relative to the put-on-body. In this way, a reliable function of the transport apparatus can be ensured.

The bearing element can be or comprise, for example, a rolling bearing, although in practice a ball bearing can prove advantageous.

Alternatively or additionally, a plain bearing can be provided, for example.

The put-on-body is preferably configured to be secured against rotation relative to the support body, in particular its connecting portion. In practice, it may be sufficient for this purpose, for example, if a sufficient force-fitting connection, in particular a frictional connection, is achieved as a result of the dimensions and/or material properties of the put-on-body.

The bearing element comprises or forms, for example, a bearing ring, which can be arranged in a radially positive-locking manner between a circumferential, axially extended edge element of the put-on-body and a circumferential step of the transport body.

The bearing ring can rest directly or indirectly, for example via a fixing element, against the put-on-body and/or the transport body. For this purpose, a corresponding step or shoulder can be formed on the put-on-body and/or the transport body.

It can be provided that the bearing element is axially supported on a fixing element, in particular an annular fixing element, which is firmly connected to the put-on-body and projects radially in one direction, in particular radially inwards, beyond the bearing element. At the projecting section, the fixing element can be connected, for example, to the put-on-body.

In a corresponding manner, the bearing element can be axially supported on a fixing element, in particular an annular fixing element, which is firmly connected to the transport body and projects radially in one direction, in particular radially outwards, beyond the bearing element. At the projecting section, the fixing element is connected, for example, to the transport body.

The connection of the respective fixing element having the put-on-body or the transport body is carried out, for example, by screwing, although another type of fixation is conceivable.

The transport body can, for example, be a transport wheel, along whose outer circumference container receptacles are arranged.

The container receptacles are configured, for example, for receiving the containers in a clamping manner.

Alternatively or additionally, receiving can be carried out, for example, by means of negative pressure in the container receptacles. For this purpose, the transport apparatus can comprise a vacuum generating device and suction conduits, which can be acted upon by it, at the container receptacles.

In a preferred embodiment, the transport body can have a convex shape, for example on a side facing away from the base device, having an apex region lying on the rotational axis or extending about the rotational axis. This can be advantageous for WIP applications, for example, as cleaning fluid can drain off from the transport body.

It may be advantageous if the transport body has a continuous surface free of openings and steps on an upper side facing away from the base device. This reduces the likelihood of deposits forming on the upper side, such as particles or cleaning fluid in WIP applications.

The magnetically active coupling elements can, for example, in each case comprise a disk-shaped receiving element and magnetic elements that are arranged in receptacles of the receiving element.

The magnetic elements are positioned relative to one another in a Halbach array arrangement, for example.

It may be advantageous if the support body comprises a lid-shaped or cap-shaped cover element, which preferably closes the receiving chamber in a sealing manner. The cover element covers, for example, the first coupling element and closes off the receiving chamber in the direction of the put-on-device.

The cover element can advantageously comprise or form a planar contact element for surface-to-surface contact with the put-on-body. Here, the above-mentioned contact element of the put-on-body preferably rests against the contact element of the cover element.

The support body preferably comprises a column element, in which a drive shaft is arranged which is connected in a rotationally fixed manner to the first coupling element and can be driven about the rotational axis. The drive shaft is, for example, guided through a through-opening of the column element and engages in the receiving chamber of the base device, in which the drive shaft is directly or indirectly connected to the first coupling element.

It can be provided that a carrier element of the support body is fixed to the end of the column element, which projects radially outwards beyond the column element with a support edge and delimits the receiving chamber. The column element is, for example, part of the connecting portion and delimits the receiving chamber on the side facing away from the put-on-body and/or radially on the outside.

The cover element is preferably connected to the carrier element in a sealing manner, wherein the cover element preferably engages over the carrier element radially on the outside.

The base device can, for example, comprise at least one bearing element via which the drive shaft is rotatably mounted relative to the column element. As a result, the reliable functioning of the transport apparatus is ensured.

The bearing element can be or comprise a rolling bearing, for example. In practice, for example, a ball bearing may prove suitable.

Alternatively or additionally, a plain bearing, for example, can be provided as a bearing element.

It is advantageous if the transport apparatus comprises a drive unit that is directly or indirectly coupled to the first coupling element.

Format parts have already been discussed. The transport apparatus can, for example, comprise two or more put-on-devices that can be selectively connected to the base device, wherein the respective at least one container receptacle of the transport apparatuses differs from one another with regard to at least one container-specific property. Accordingly, the put-on-device can be a format part that can be connected to the base device depending on the containers to be processed.

It can be provided that the transport apparatus comprises a decoupling mechanism, with which the magnetic engagement of the coupling elements with one another can be canceled. This makes it easier to separate the put-on-body from the connecting portion, which can be detachably connected to one another, as explained above. For example, the decoupling mechanism moves the coupling elements apart from one another, so that the magnetic force drops to such an extent that the put-on-body can be easily removed.

The decoupling mechanism can, for example, comprise an adjusting unit with which the first coupling element can be moved in a direction pointing away from the second coupling element, in particular via a drive shaft connected to the first coupling element. The adjusting unit can act on the coupling element directly or indirectly via the drive shaft. By moving away from the second coupling element, the distance between the coupling elements is increased.

The adjusting unit can be configured in different ways. In practice, a pneumatic configuration proves to be advantageous, wherein a different type of adjusting unit, such as an electric one, can also be provided.

It can be provided that the first coupling element, in particular via the drive shaft, is movable in a direction pointing towards the second coupling element via the adjusting unit. For example, for starting up the transport apparatus, the put-on-body is initially placed on the connecting portion, the drive shaft is moved with the first coupling element and the coupling elements are thereby brought into magnetic engagement with one another.

The drive shaft can be displaced axially in particular via the adjusting unit.

As mentioned, the adjusting unit can be configured pneumatically and therefore be or comprise a piston-cylinder unit.

The movement of the coupling element by means of the adjusting unit away from the second coupling element can, for example, be carried out counter to the action of a return unit. The return unit comprises, for example, a mechanical return element, for example in the form of a tension spring or a compression spring. The return unit can form a preloading unit, wherein the drive shaft and the first coupling element are preloaded by means of the return element in the direction of the second coupling element, even if the adjusting unit is not active.

The adjusting unit can, for example, be connected in an articulated manner to the drive shaft or to a bearing element that supports the drive shaft. For example, an articulation member is articulated on the drive shaft or the bearing element and on the adjusting unit, for example a piston thereof. The return element can, for example, act on the articulation member.

The articulation member can be a lever or form a lever. The adjusting unit can act on a first lever arm. For example, a stationary bearing, which can be fixed to a frame for the transport apparatus, engages a second lever arm.

As already mentioned, the present disclosure also relates to a system for processing containers.

A system in accordance with the disclosure for processing containers, in particular pharmaceutical containers, comprises a frame and at least one transport apparatus in accordance with the first aspect.

Advantages already mentioned in connection with the explanation of the transport apparatus in accordance with the disclosure can also be achieved with the system. In this regard, reference can be made to the above statements.

Advantageous embodiments of the system in accordance with the disclosure result from advantageous embodiments of the transport apparatus in accordance with the disclosure. In this regard, also, reference can be made to the above statements.

The frame can also be referred to as a substructure, for example. For example, the transport apparatus can be positioned entirely or partially on the frame. The system can comprise or form a superstructure, for example a hood. An isolator device for providing a decontamination atmosphere can be provided.

The structure of the transport apparatus is advantageously suitable for its use in laminar flow (LF), which prevails during the production cycle for avoiding turbulence in the air flow, as a result of which contamination by stirred-up particles can be avoided.

The frame can comprise a separating element, for example a plate or the like, which divides the system into a zone and a second zone, wherein the first zone has a higher degree of purity than the second zone and in particular can be a clean room zone.

The transport apparatus can be arranged at least with the put-on-device in the first zone. The system can have a drive unit in the second zone, wherein a drive element for the first coupling element is guided through a through-opening in the first zone. The drive unit and/or the drive element can be part of the transport apparatus, which can accordingly be arranged at least in sections in the first zone. Due to the zone separation, the drive unit can be located in the less clean second zone.

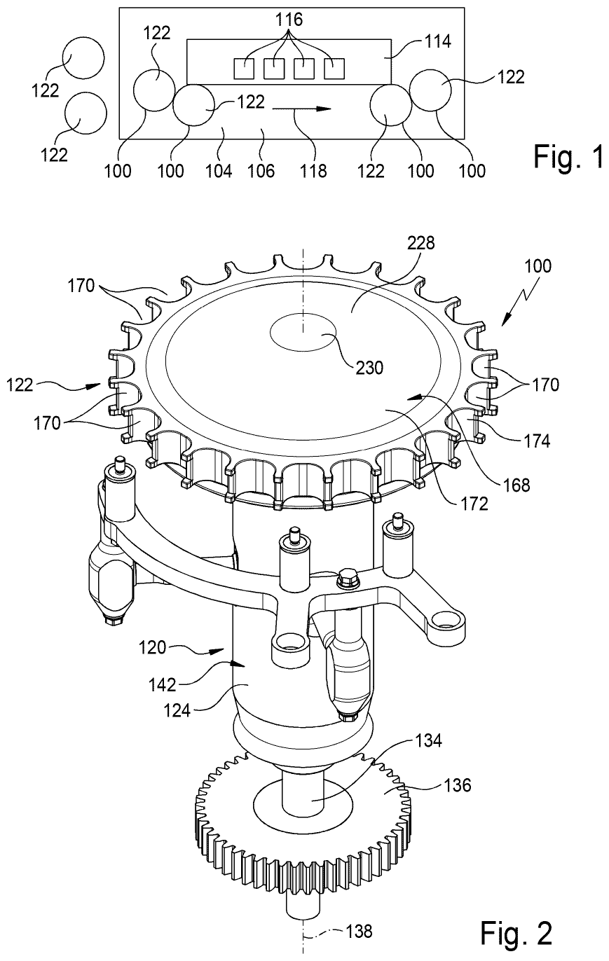

In the drawing, a transport apparatus in accordance with the disclosure, designated as a whole by reference numeral 100, is shown in a preferred embodiment. The transport apparatus 100 is comprised, for example, of a system 102 in accordance with the disclosure, shown schematically in FIG. 1 with the reference numeral and in a preferred embodiment.

The system 102 can be used in particular to process pharmaceutical containers that are not shown in the drawing. The containers are, for example, vials, syringes, cartridges or ampoules.

The system 102 comprises a frame 104 that is positioned on a set-down surface (not shown in the drawing) and that separates a first zone 110 from a second zone 112 via a plate 108 forming a separating element 106. The first zone 110 is arranged above the plate 108 in relation to the intended use and is, for example, a clean room zone whose degree of purity is higher than that of the second zone 112.

The system 102 or the frame 104 can comprise, for example, a hood-like cover for the plate 108 or an isolator device for providing a decontamination atmosphere.

For processing the containers, the system 102 has a transport apparatus 114 on which a plurality of stations 116 are arranged. The stations 116 comprise, in relation to a transport direction 118, for example, a first weighing station, a filling station, a second weighing station and a closing station.

For example, at least one further transport apparatus is present on the coupling side and the uncoupling side of the transport apparatus 114. In the present case, this is the transport apparatus 100 in accordance with the disclosure, a plurality of which can also be connected in series.

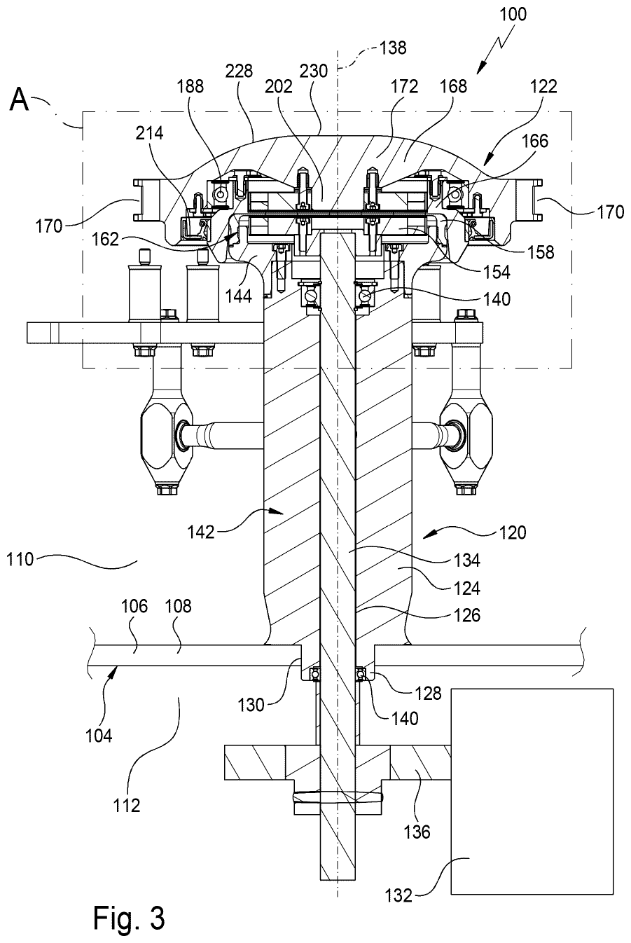

As can be seen, in particular, in FIGS. 2 and 3, the transport apparatus 100 comprises a base device 120 and a put-on-device 122. In the present example, the put-on-device 122, as explained below, is placed on the base device 120 from above and arranged above it. However, the disclosure is not limited hereto.

The base device 120 comprises a substantially cylindrically extending column element 124, which centrally comprises a passage 126. The column element 124 is supported on the upper side of the separating element 106 and extends with a lower end portion 128 through a through-opening 130 formed in the separating element 106.

In the second zone 112, a drive unit 132 of the transport apparatus 100, shown schematically in FIG. 3, is arranged. The drive unit 132 is coupled to a drive shaft 134 arranged in the passage 126, in the present case via a drive element 136 in the form of a drive wheel.

The drive shaft 134 is aligned coaxially with the column element 124 and defines a rotational axis 138 about which the drive shaft 134 can be driven in rotation. Here, it is conceivable that, depending on the function of the drive unit 132, both directions of rotation about the rotational axis 138 can be executed.

The drive shaft 134 is rotatably mounted relative to the column element 124 via at least one bearing element 140. In the present case, two axially mutually spaced bearing elements 140 are provided. A first bearing element 140 is arranged near the put-on-device 122. A second bearing element 140 is arranged on the lower side on the end portion 128.

In the present case, the bearing elements 140 are rolling bearings, which are configured as ball bearings. The use of plain bearings is conceivable as an alternative or in addition.

The column element 124 is part of a support body 142 of the base device 120. Above the column element 124, the support body 142 comprises a carrier element 144. The carrier element 144 sits on a shoulder-shaped contact element 146 of the column element 124 and extends upwards.

The carrier element 144 is fixed to the column element 124 and projects radially beyond the column element 124 with a support edge 148. Axially, a circumferential edge element 150 of the carrier element 144 extends from the support edge about the rotational axis 138.

The carrier element 144 delimits in sections a receiving chamber 152 of the base device from below, which is furthermore delimited on the lower side by the upper end of the column element 124.

The drive shaft 134 engages in the receiving chamber 152 and is, for example, indirectly connected to a first coupling element 154 arranged in the receiving chamber 152. In the present case, the first coupling element 154 is connected, for example by screwing, to a flange 156, which is mounted on the drive shaft 134 in a positive-locking manner. Other types of connection of the coupling element 154 to the drive shaft 134 are conceivable.

The flange 156 and the drive element 136 are aligned coaxially with the drive shaft 134.

The support body 142 further comprises a lid-shaped cover element 158, which closes and covers the receiving chamber 152 on the upper side. The cover element 158 has a downwardly extending edge element 160. The edge element 160 engages over the edge element 150 and is connected to it. As a result, the receiving chamber 152 is sealed from the outside and outwards.

Due to the configuration of the carrier element 144 and the cover element 158, the support body 142 thus expands upwards in the radial direction and forms a connecting portion 162.

On the upper side, adjacent to the put-on-device 122, the cover element 158 forms a planar contact element 164. In the present case, the plane defined by the contact element 164 is aligned perpendicular to the rotational axis 138.

The put-on-device 122 comprises an put-on-body 166 and a transport body 168, which in each case are aligned coaxially with the support body 142 and the drive shaft 134. The put-on-body 166 serves to connect the put-on-device 122 to the base device 120. The transport body 168 is configured to be rotatable relative to the put-on-body 166 about the rotational axis 138 and comprises a plurality of container receptacles 170 for the containers to be transported.

The transport body 168 is configured as a transport wheel 172, on whose outer circumference 174 the container receptacles 170 are arranged. Another designation for the transport body 168 is transport star.

The transport apparatus 100 can comprise a plurality of put-on-devices 122, which are shown schematically in FIG. 1 by way of example, in addition to the put-on-device 122 connected to the base device 120.

The put-on-devices 122 differ in particular in that the container receptacles 170 differ from one another in at least one container-specific property. The put-on-devices 122 are accordingly so-called format parts, which can be used for transporting different containers in each case. Each put-on-device 122 can advantageously cover a specific format range. Depending on the respective requirements, the appropriate put-on-device 122 can be connected to the base device 120.

It can be provided that, in each case, only the transport bodies 168 are format parts that can be exchanged and connected to the otherwise retained put-on-body 166.

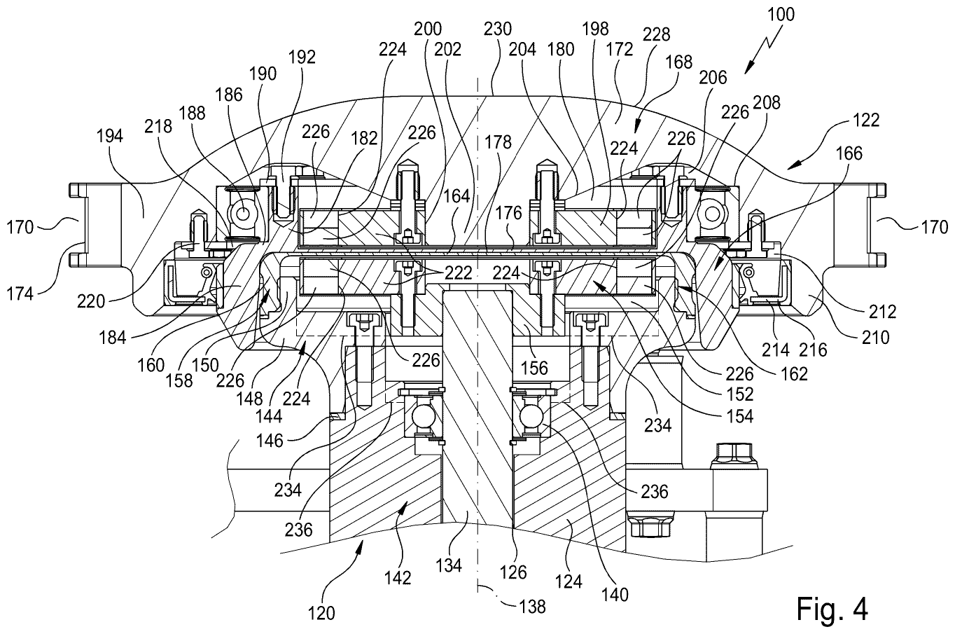

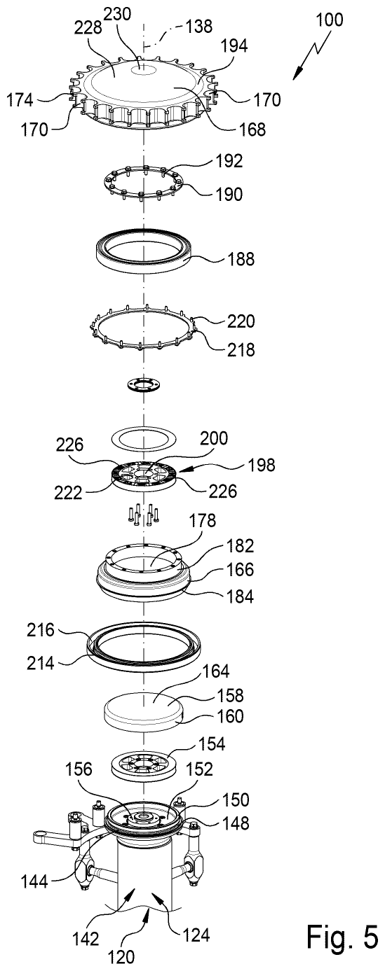

As can be seen in particular from FIGS. 4 and 5, the put-on-body 166 is connected to the connecting portion 162. The put-on-body 166 rests against the connecting portion 162 and, in the present exemplary embodiment, in particular on the upper side of the connecting portion 162. For this purpose, the put-on-body 166 defines a planar contact element 176. The contact element 176 lies with surface-to-surface contact against the contact element 164, as a result of which a reliable relative positioning of the devices 120, 122 is ensured.

The contact element 176 simultaneously forms a base 178 of a receiving chamber 180. The receiving chamber 180 is arranged on the side of the put-on-body 166 facing away from the support body 142.

Pointing away from the support body 142, the put-on-body 166 comprises an edge element 182. The edge element 182 completely surrounds the receiving chamber 180 in the circumferential direction of the rotational axis 138 and forms an outer wall for the receiving chamber 180.

The edge element 182 is spaced in the radial direction from the rotational axis 138 approximately as far as the edge elements 150, 160 of the carrier element 144 and the cover element 158, respectively.

The put-on-body 166 engages over the connecting portion 162 and comprises, in the present case radially on the outside, an edge element 184. The edge element 184 surrounds the connecting portion 162 radially on the outside along the entire circumference about the rotational axis 138. Here, it can advantageously be provided that the edge element 184 rests against the outside at least on the edge element 160 of the cover element 158, advantageously also on the outer circumference of the carrier element 144. Accordingly, it may be advantageous if the edge element 184 surrounds the connecting portion 162 in a sealing manner.

Overall, the put-on-body 166 completely covers the support body 142 at the connecting portion 162.

At the connecting portion 162, the put-on-body is reliably held by form-fitting connection and a force-fitting connection, in particular a frictional connection. For connection purposes, it proves to be advantageous that the put-on-body 166 is made of an elastically deformable material. This allows, for example, the put-on-body 166 to be snapped onto the connecting portion 162.

The put-on-body 166 is made, for example, of polyoxymethylene (POM), polyethylene (PE) or polyetheretherketone (PEEK).

The put-on-body 166 and thus the put-on-device 122 can be detached from the support body 142 by applying a pulling force upwards away from the support body 142. Due to the detachable connection, the different put-on-devices 122 can be selectively connected to the base device 120 without tools.

In the transition region of the edge element 182 to the edge element 184, a step 186 is formed on the put-on-body 166. A bearing element 188 of the put-on-device 122 rests against the step 186 and in the present case rests against the step 186. In the radial direction, the bearing element 188 is supported on the edge element 182.

The bearing element 188 serves to rotatably support the transport body 168 relative to the put-on-body 166. In the present case, the bearing element 188 is configured as a rolling bearing, in particular as a ball bearing. Alternatively or additionally, the use of a plain bearing is conceivable.

A fixing element 190 is provided for fixing to the put-on-body 166. In the present example, the fixing element 190 is configured as a fixing ring on which the bearing element 188 can be supported from below. Accordingly, the fixing element 190 rests against the bearing element 188 from above. It projects radially inwards beyond the bearing element 188.

In the present example, the fixing element 190 is connected to the put-on-body 166 by screwing, in particular to the edge element 182. The reference numeral 192 designates the corresponding screw element, which couples to a bushing received in the edge element 182. A different form of fixation is conceivable.

The transport body 168 covers the put-on-body 166. In the radial direction, the transport body 168 projects beyond the put-on-body 166 with a protruding region 194.

For driving the transport body 168, the put-on-device 122 comprises a second coupling element 198. The coupling element 198 is arranged in the receiving chamber 180 and is spaced relative to the first coupling element 154. The coupling elements 154, 198 are aligned coaxially with one another.

In the present case, a rotationally fixed connection between the coupling element 198 and the transport body 168 is ensured by a screw connection. A different form of connection is conceivable.

A central opening 200 is formed in the coupling element 198, into which the transport body 168 engages in a positive-locking manner with a projection 202, so that the coupling element 198 and the transport body 168 can assume a defined relative position to one another. The projection 202 is directed in the direction of the support body 142, in the present case downwards, and rests against the base 178.

Starting from the projection 202, a lower wall 204 of the transport body 168 runs radially outwards at an angle upwards, so that a circumferential concave recess 206 is formed on the lower side of the transport body 168. In the present case, the screw elements 192 are arranged in the recess 206.

Further radially outwards, the lower wall 204 runs downwards again and forms a step 208. The bearing element 188 rests against the step 208.

Further running radially outwards, the lower wall 204 runs further downwards. At the protruding region 194, the transport body 168 has a downwardly extending edge element 210. The edge element 210 extends axially approximately as far as the edge element 160 of the cover element 158.

In the present case, “downwards” refers to the desired position in which the put-on-device 122 is placed on the upper side of the base device 120.

An intermediate space 212 is formed between the edge element 210 of the transport body 168 and the edge element 184 of the put-on-body 166. The intermediate space 212 is sealed by a circumferential sealing element 214. In the present case, the sealing element 214 is configured as a shaft sealing ring 216 or comprises such a ring.

A fixing element 218 is provided for fixing the bearing element 188 to the transport body 168. In the present case, the fixing element 218 is a fixing ring. The bearing element 188 is supported on the upper side on the fixing ring, which projects in the radial direction outwards beyond the bearing element 188.

In the present case, the fixing element 218 is fixed to the transport body 168 by screwing (screw element 220). A different form of fixation is conceivable. The fixation is carried out above the intermediate space 212, which is sealed by the shaft sealing ring 216.

In the present case, the coupling elements 154, 198 are magnetically coupled together via magnetic elements, in order to transmit the rotational movement of the drive shaft 136 to the transport body 168.

For this purpose, in the present example, each coupling element 154, 198 comprises a disk-shaped receiving element 222 in which in each case receptacles 224 are formed. Magnetic elements 226 are arranged in the receptacle 224, which in the present case form, for example, a Halbach array arrangement.

In the present case, an upper side 228 of the transport body 168 is smooth and has a continuous surface free of openings and steps. This avoids the deposits of particles or residues during cleaning applications.

On the side facing away from the base device 120, the transport body 168 has a convex shape, wherein an apex region 230 is formed about the rotational axis 138. Starting from the apex region 230, the upper side 228 is convexly curved downwards. Radially tapering, the upper side runs perpendicular to the rotational axis 138 in the transition to the container receptacles 170.

The transport apparatus 100 has an advantageous cleanability. It is advantageous that the receiving chambers 152 and 180 are sealed outwards and from the outside. As a result, the entry of particles from outside is effectively avoided. Conversely, no particles escape from the receiving chambers 152, 180 to the outside, preventing contamination of the first zone 110.

The carrier element 144 and the cover element 158 along with the put-on-body 166 serve in particular to seal the receiving chamber 152.

The sealing of the receiving chamber 180 is ensured in particular by the transport body 168 and the shaft sealing ring 216.

Despite the advantageous sealing, the driving force of the drive unit 132 can be transmitted to the transport body 168. For this purpose, it proves to be particularly advantageous that the coupling elements 154, 198 are magnetically coupled together, wherein in each case they are arranged in the receiving chamber 152 or 180 and are thereby mutually spaced (axially).

The transport apparatus 100 is, for example, advantageously suitable for liquid cleaning in the so-called WIP process (WIP, washing-in-place). Disassembly is not required. The transport apparatus 100 can, for example, be rinsed from above with the cleaning liquid. Due to the concave shape of the transport body 168 and the continuous upper side 228, the cleaning liquid can drain off without adhering to the transport body 168. The entry of cleaning fluid under the transport body 168 is prevented by the shaft sealing ring 216, the entry of fluid between the put-on-device 122 and the base device 120 is prevented by the put-on-body 166.

The structure of the transport apparatus 100 also proves to be advantageous for applications in a decontamination atmosphere, for example in an isolator device in which a laminar flow (LF) of a gas prevails during the production cycle. Due to the laminar flow, turbulence in the airflow is avoided, as a result of which contamination by stirred-up particles can be avoided.

As already mentioned, it is advantageous that the put-on-device 122 can be detachably connected to the base device 120, which makes versatile use possible due to the format parts.

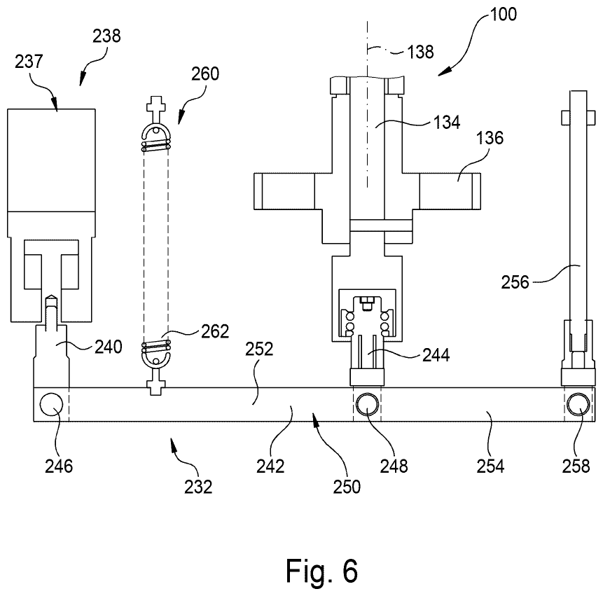

FIG. 6 shows a schematic representation of a preferred embodiment of the disclosure of a lower end of the transport apparatus 100 with the drive shaft 134 and the drive element 136, for example arranged in the second zone 112. For the sake of clarity, the drive unit 132 is not shown.

FIG. 6 also schematically shows a decoupling mechanism designated by the reference numeral 232. The magnetic engagement of the coupling elements 154, 198 with one another can be canceled via the decoupling mechanism 232. This makes it easier to pull the put-on-body 166 off the connecting portion 162 and thereby detach the put-on-device 122 from the base device 120.

In the present case, the decoupling occurs by moving the drive shaft 134, which is connected in a rotationally fixed manner to the coupling element 154, in a direction pointing away from the second coupling element 198. In the present case, the movement is an axial displacement.

In order to make this displacement easier, different types of bearing elements can be used, for example, instead of the bearing elements 140. For example, rolling bearings in the form of linear ball bearings are a suitable option.

So that the first coupling element 154 can be moved sufficiently far away from the second coupling element 198, the receiving chamber 152 can have a greater axial extent and be higher than in the representation shown in FIGS. 3 and 4. For example, a dashed line 234 schematically shows a lower position of the base of the receiving chamber 152. It is understood that the further components of the base device 120 (for example, the screws shown in FIG. 3) can be laid axially downwards in a corresponding manner. A dashed line 236 schematically shows the shifting of a shoulder on the column element 124 axially downwards, so that the flange 156 can be moved out of the receiving chamber 152 when the drive shaft 134 is displaced.

It is further understood that any bearing for the drive shaft 134 is positioned outside the displacement range.

In the present case, the adjustment mechanism comprises an adjusting unit 237 in the form of a piston-cylinder unit 238. The piston-cylinder unit 238, for example, is fixed in place to the frame 104. For example, the piston-cylinder unit 238 is configured pneumatically.

A piston 240 of the unit 238 can be displaced, wherein FIG. 6 shows a basic position in which the coupling elements 154, 198 are magnetically engaged with one another for the intended use of the transport apparatus 100.

In the present case, the piston 240 is connected in an articulated manner via an articulation member 242 to a bearing element 244 on which the drive shaft 134 is rotatably mounted. As a result, an indirect connection between the piston-cylinder unit 238 and the drive shaft 134 is created. The reference numerals 246, 248 designate the respective joints.

In the present example, the articulation member 242 is configured as a two-armed lever element 250, the first lever arm 252 of which is effective between the piston-cylinder unit 238 and the bearing element 244, and which comprises a second lever arm 254.

The lever arm 254 acts between the bearing element 244 and a fixing part 256, which is connected to the articulation member 242 at a joint 258. The fixing part 256 is, for example, fixed in place on the frame 104.

In the present case, the lever arm 252 is longer than the lever arm 254, so that the lever element 250 is force-amplifying.

When the piston 240 is displaced into a decoupling position (not shown in the drawing), the articulation member 242 pivots relative to the fixing part 256. As a result, the drive shaft 134 and with it the coupling element 154 are moved away from the coupling element 198. As the distance between the coupling elements 154, 198 increases, the magnetic force weakens and the coupling elements are disengaged. This makes it easier to detach the put-on-body 166 from the connecting portion 162.

Conversely, the coupling elements 154, 198 can be magnetically engaged.

It can be provided, for example, that the piston-cylinder unit is double-acting. Under its effect, the drive shaft 134 and thus the coupling element 154 can be displaced again in the direction of the coupling element 198.

Alternatively or additionally, the decoupling mechanism 232 can comprise a return unit 260. The return unit 260 is effective, for example, between the frame 104 and directly or indirectly the drive shaft 134. In the present case, the return unit 260 is connected to the articulation member 242.

The return unit 260 comprises a return element 262, which in the present case is configured as a mechanical spring. In the present example, this spring is a tension-acting coil spring.

The transfer of the piston 240 for decoupling the coupling elements 154, 198 is carried out against a restoring force of the return element 262. The restoring force is effective if the coupling elements 154, 198 are to be brought into engagement again. The return unit 260 is suitable, for example, for use with a single-acting piston-cylinder unit 238, but it can also support a double-acting unit 238.

The return unit 260 can be configured as a preloading unit, so that the force of the return element 262 also acts if the coupling elements 156, 198 are magnetically engaged with one another.

The decoupling mechanism 232 can be configured differently from the manner described above, which is given only as an example.

### LIST OF REFERENCE NUMERALS

100 Transport apparatus
102 System
104 Frame
106 Separating element
108 Plate
110 First zone
112 Second zone
114 Transport apparatus
116 Station
118 Transport direction
120 Base device
122 Put-on-device
124 Column element
126 Passage
128 End portion
130 Through-opening
132 Drive unit
134 Drive shaft
136 Drive element
138 Rotational axis
140, 188 Bearing element
142 Support body
144 Carrier element
146, 164, 176 Contact element
148 Support edge
150, 160, 182, 184, 210 Edge element
152, 180 Receiving chamber
154 First coupling element
156 Flange
158 Cover element
162 Connecting portion
166 Put-on-body
168 Transport body
170 Container receptacle
172 Transport wheel
174 Outer circumference
178 Base
186, 208 Step
190, 218 Fixing element
192, 220 Screw element
194 Protruding region
198 Second coupling element
200 Opening
202 Projection
204 Lower wall
206 Recess
212 Intermediate space
214 Sealing element
216 Shaft sealing ring
222 Receiving element
224 Receptacle
226 Magnetic element
228 Upper side
230 Apex region
232 Decoupling mechanism
234, 236 Dashed line
237 Adjusting unit
238 Piston-cylinder unit
240 Piston
242 Articulation member
244 Bearing element
246, 248, 258 Joint
250 Lever element
252, 254 Lever arm
256 Fixing part
258 Joint
260 Return unit
262 Return element

1. A transport apparatus for pharmaceutical containers, the transport apparatus comprising:
a base device; and
at least one put-on-device,
the base device comprising a support body for the at least one put-on-device and a first coupling element configured to be driven in rotation about a rotational axis via a drive unit,
the support body having a connecting portion facing the at least one put-on-device, on which a receiving chamber is formed in which the first coupling element is arranged,
the at least one put-on-device comprising a transport body, a plurality of container receptacles, a second coupling element connected to the transport body in a rotationally fixed manner, and a put-on-body,
the first coupling element and the second coupling element being mutually spaced and magnetically couple together to drive the transport body about the rotational axis,
the put-on-body resting against the connecting portion and connected to the connecting portion via at least one of a force-locking connection and a positive-locking connection, and
the transport body being configured to:
be rotatable relative to the put-on-body,
cover the put-on-body, and
project beyond the put-on-body in a radial direction.

2. The transport apparatus according to claim 1, wherein:
at least one of the following applies:
the put-on-body covers the support body at the connecting portion at least partially; and
the put-on-body comprises or forms a planar contact element for surface-to-surface contact with the connecting portion, at a cover element of the support body covering the receiving chamber.

3. The transport apparatus according to claim 1, wherein:
the put-on-body engages over the connecting portion and comprises an edge element that surrounds the connecting portion radially on an outside at least in sections, and
the edge element rests against the connecting portion at least in sections along an outer circumference.

4. The transport apparatus according to claim 3, wherein the edge element extends axially over at least one of a height of the receiving chamber and a height of a cover element of the support body covering the receiving chamber.

5. The transport apparatus according to claim 1, wherein at least one of the following applies:
the put-on-body is made of an elastically deformable material;
the put-on-body is snapped onto the connecting portion;
the put-on-body is detachably connectable to the connecting portion, wherein the at least one put-on-device is detachably connectable to the base device via the put-on-body; and
the put-on-body is configured in one piece.

6. The transport apparatus according to claim 1, wherein the put-on-body comprises an edge element pointing away from the support body that at least partially surrounds a receiving chamber for the second coupling element in a circumferential direction.

7. The transport apparatus according to claim 1, wherein at least one of the following applies:
the transport body covers the receiving chamber and projects radially beyond the receiving chamber; and
a central opening is formed on the second coupling element, into which the transport body engages with a projection, wherein the projection rests against the put-on-body in a region of the central opening.

8. The transport apparatus according to claim 1, wherein a sealing element is arranged radially between an edge element of the put-on-body and an edge element of the transport body for sealing an intermediate space between the put-on-body and the transport body.

9. The transport apparatus according to claim 8, wherein the sealing element is a shaft sealing ring or comprises a shaft sealing ring.

10. The transport apparatus according to claim 1, wherein:
the at least one put-on-device comprises a bearing element via which the transport body is rotatable relative to the put-on-body, and
the bearing element is or comprises a rolling bearing or a plain bearing.

11. The transport apparatus according to claim 10, wherein at least one of the following applies:
the bearing element comprises or forms a bearing ring which is arranged in a radially positive-locking manner between a circumferential, axially extending edge element of the put-on-body and a circumferential step of the transport body;
the bearing element is axially supported on a fixing element which is firmly connected to the put-on-body and projects radially inwards in one direction beyond the bearing element; and
the bearing element is axially supported on a fixing element which is firmly connected to the transport body and projects radially outwards in one direction beyond the bearing element.

12. The transport apparatus according to claim 1, wherein the transport body is a transport wheel, along an outer circumference of which the plurality of container receptacles are arranged.

13. The transport apparatus according to claim 1, wherein the transport body has a convex shape on a side facing away from the base device having an apex region lying on the rotational axis or extending about the rotational axis and/or wherein the transport body has a continuous surface free of openings and of steps on an upper side facing away from the base device.

14. The transport apparatus according to claim 1, wherein:
the first coupling element and the second coupling element each comprise a receiving element that is disk-shaped and magnetic elements that are arranged in receptacles of the receiving element, and
the magnetic elements are positioned relative to one another in a Halbach array arrangement.

15. The transport apparatus according to claim 1, wherein the support body comprises a cover element that is lid-shaped or cap-shaped, the cover element closing the receiving chamber in a sealing manner.

16. The transport apparatus according to claim 15, wherein the cover element comprises or forms a planar contact element for surface-to-surface contact with the put-on-body.

17. The transport apparatus according to claim 1, wherein the support body comprises a column element, in which a drive shaft is arranged which is connected in a rotationally fixed manner to the first coupling element and is able to be driven about the rotational axis.

18. The transport apparatus according to claim 17, wherein:
a carrier element of the support body is fixed to an end of the column element, and
the carrier element projects radially outwardly beyond the column element with a support edge and delimits the receiving chamber.

19. The transport apparatus according to claim 17, wherein:
the base device comprises at least one bearing element, and
the drive shaft is rotatably mounted relative to the column element via the at least one bearing element.

20. The transport apparatus according to claim 1, wherein the transport apparatus comprises a drive unit that is directly or indirectly coupled to the first coupling element.

21. The transport apparatus according to claim 1, wherein:
the at least one put-on-device comprises a first put-on-device with a plurality of first container receptacles and a second put-on-device with a plurality of second container receptacles,
each of the first put-on-device and the second put-on-device being selectively connectable to the base device, and
the plurality of first container receptacles differing from the plurality of second container receptacles with regard to at least one container-specific property.

22. The transport apparatus according to claim 1, wherein the transport apparatus comprises a decoupling mechanism configured to disengage a magnetic engagement of the first coupling element and the second coupling element.

23. The transport apparatus according to claim 22, wherein the decoupling mechanism comprises an adjusting unit with which the first coupling element is movable in a direction pointing away from the second coupling element and/or with which the first coupling element is movable in a direction pointing towards the second coupling element.

24. The transport apparatus according to claim 23, wherein at least one of the following applies:
the adjusting unit is or comprises a piston-cylinder unit;
movement of the first coupling element by the adjusting unit away from the second coupling element is carried out counter to an action of a return unit; and
the adjusting unit is connected in an articulated manner to a drive shaft connected to the first coupling element or to a bearing element that supports the drive shaft via an articulation member.

25. A system for processing pharmaceutical containers, the system comprising:
a frame; and
at least one transport apparatus,
the at least one transport apparatus comprising a base device and a put-on-device,
the base device comprising a support body for the put-on-device and a first coupling element configured to be driven in rotation about a rotational axis via a drive unit,
the support body having a connecting portion facing the put-on-device, on which a receiving chamber is formed in which the first coupling element is arranged,
the put-on-device comprising a transport body, a plurality of container receptacles, a second coupling element connected to the transport body in a rotationally fixed manner, and a put-on-body,
the first coupling element and the second coupling element being mutually spaced and magnetically coupled together to drive the transport body about the rotational axis,
the put-on-body resting against the connecting portion and connected to the connecting portion via at least one of a force-locking connection and a positive-locking connection, and
the transport body configured to:
be rotatable relative to the put-on-body,
cover the put-on-body, and
project beyond the put-on-body in a radial direction.

26. The system according to claim 25, wherein:
the frame comprises a separating element that divides the system into a first zone and a second zone,
the first zone has a higher degree of purity than the second zone,
the at least one transport apparatus is arranged in the first zone at least with the put-on-device,
a drive unit of the system is arranged in the second zone, and
a drive element for the first coupling element is guided through a through-opening into the first zone.
